(19) United States
(12) Patent Application Publication
(10) Pub. No.: US 2017/0033866 A1
(43) Pub. Date: Feb. 2, 2017

(54) Method and Apparatus for Monitoring Optical Signal-to-Noise Ratio

(71) Applicant: Huawei Technologies Co., Ltd., Shenzhen (CN)

(72) Inventors: Dawei Wang, Munich (DE); Huixiao Ma, Shenzhen (CN)

(21) Appl. No.: 15/295,203

(22) Filed: Oct. 17, 2016

Related U.S. Application Data
(63) Continuation of application No. PCT/CN2014/075587, filed on Apr. 17, 2014.

(51) Int. Cl. H04B 10/079; H04B 10/077

(52) U.S. Cl. CPC H04B 10/07953; H04B 10/077

(57) ABSTRACT

A method and an apparatus for monitoring an optical signal-to-noise ratio (OSNR) is provided. The method includes coupling a to-be-tested signal with a particular noise signal, to obtain a composite signal, where the particular noise signal is a noise signal that makes an OSNR of a signal of a to-be-tested channel in the composite signal be within a preset OSNR range. The method also includes determining an OSNR of the signal of the to-be-tested channel in the to-be-tested signal according to an optical spectrum of the composite signal and a power of the particular noise signal.

### CROSS-REFERENCE TO RELATED APPLICATIONS

This application is a continuation of International Application No. PCT/CN2014/075587, filed on Apr. 17, 2014, the disclosure of which is hereby incorporated by reference in its entirety.

### TECHNICAL FIELD

The present invention relates to the field of optical communications technologies, and in particular, to a method and an apparatus for monitoring an optical signal-to-noise ratio in an optical communications network.

### BACKGROUND

In an optical communications network, an optical signal-to-noise ratio (OSNR) is a key indicator for measuring performance of an optical signal. A definition of the optical signal-to-noise ratio is a ratio of a power of an optical signal not including noise to a power of noise in a bandwidth of 0.1 nm.

In an optical communications network on which OSNR monitoring needs to be performed, to avoid communication interruption, generally a few optical signals transmitted in the network are acquired as to-be-tested signals. Because the optical signals in the optical communications network are transmitted on multiple channels, the to-be-tested signals also include signals of multiple channels. The OSNR monitoring specifically refers to OSNR monitoring on a signal of a channel (that is, a to-be-tested channel) among the to-be-tested signals. Currently, a common OSNR monitoring method is an out-of-band noise monitoring method. In an OSNR out-of-band noise monitoring method defined in ITU-T G.697, optical spectrum analysis needs to be performed on an acquired to-be-tested signal. In a low-speed optical communications network, an acquired optical spectrum is similar to what is shown in FIG. 1 (the horizontal axis represents wavelength, and the vertical axis represents power). A peak power at a center wavelength νᵢ of a to-be-tested channel is a power of an optical signal including noise, that is, the sum of a power Pᵢ of an optical signal not including noise and a power Nᵢ of noise in the channel; a power N(νᵢ−Δν) of inter-channel noise at Δν on the left of the center wavelength νᵢ of the to-be-tested channel and a power N(νᵢ+Δν) of inter-channel noise at Δν on the right of the center wavelength νᵢ of the to-be-tested channel are acquired according to the optical spectrum. Differences between the power of the noise in the channel and the powers of the inter-channel noise are not very great. Therefore, a linear interpolant of the two powers N(νᵢ−Δν) and N(νᵢ+Δν) of the inter-channel noise may be equivalent to the power Nᵢ of the noise in the channel. The peak power at the center wavelength νᵢ of the to-be-tested channel minus the linear interpolant may be equivalent to the power Pᵢ of the optical signal not including noise in the channel, and further, an OSNR of the signal of the to-be-tested channel in the to-be-tested signal may be calculated according to the definition of OSNR.

However, a distance between channels is relatively small in a high-speed optical communications network, and optical spectra overlap. In this case, differences between a real power of noise in a channel and powers of inter-channel noise are relatively great. If the power of the noise in the channel is obtained by measuring the powers of the inter-channel noise, there is a relatively great difference between a calculated OSNR and a real OSNR, that is, accuracy of OSNR monitoring cannot be ensured. Therefore, the foregoing out-of-band noise monitoring method cannot be applied to OSNR monitoring in a high-speed optical communications network.

### SUMMARY

Embodiments provide a method and an apparatus for monitoring an OSNR, which can ensure accuracy of OSNR monitoring.

According to a first aspect, a method for monitoring an optical signal-to-noise ratio OSNR is provided. The method includes coupling a to-be-tested signal with a particular noise signal, to obtain a composite signal, where the particular noise signal is a noise signal that makes an OSNR of a signal of a to-be-tested channel in the composite signal be within a preset OSNR range. The method also includes determining an OSNR of the signal of the to-be-tested channel in the to-be-tested signal according to an optical spectrum of the composite signal and a power of the particular noise signal.

With reference to the first aspect, in a first possible implementation manner, the determining an OSNR of the signal of the to-be-tested channel in the to-be-tested signal according to an optical spectrum of the composite signal and a power of the particular noise signal specifically includes: determining a power of an optical signal including noise in a signal bandwidth of the to-be-tested channel according to the optical spectrum of the composite signal, and separately determining powers of inter-channel noise in a preset bandwidth between the to-be-tested channel and two adjacent channels; and determining the OSNR of the signal of the to-be-tested channel in the to-be-tested signal according to the signal bandwidth of the to-be-tested channel, the preset bandwidth, the power of the optical signal including noise in the signal bandwidth of the to-be-tested channel, the powers of the inter-channel noise, and the power of the particular noise signal.

With reference to the first possible implementation manner of the first aspect, in a second possible implementation manner, the OSNR of the signal of the to-be-tested channel in the to-be-tested signal is determined specifically based on the following formula:

$$O = \frac{S - N \times BW / BW 1}{α ( N - Δ N ) \times BW / BW 1} ,$$

where

O is the OSNR of the signal of the to-be-tested channel in the to-be-tested signal;

BW is the signal bandwidth of the to-be-tested channel;

BW1 is the preset bandwidth;

S is the power of the optical signal including noise in the signal bandwidth of the to-be-tested channel;

N is a linear interpolant of the powers of the inter-channel noise;

ΔN is the power of the particular noise signal; and

α is a calibration coefficient and is related to a filtering characteristic of a transmission link of the to-be-tested channel.

With reference to the first possible implementation manner of the first aspect or the second possible implementation manner of the first aspect, in a third possible implementation manner, the preset bandwidth is less than the signal bandwidth of the to-be-tested channel.

With reference to the first aspect, the first possible implementation manner of the first aspect, the second possible implementation manner of the first aspect, or the third possible implementation manner of the first aspect, in a fourth possible implementation manner, the preset OSNR range is specifically 6 dB to 8 dB.

According to a second aspect, an apparatus for monitoring an optical signal-to-noise ratio OSNR is provided. The apparatus includes a coupling unit, configured to couple a to-be-tested signal with a particular noise signal, to obtain a composite signal, where the particular noise signal is a noise signal that makes an OSNR of a signal of a to-be-tested channel in the composite signal be within a preset OSNR range. The apparatus also includes a determining unit, configured to determine an OSNR of the signal of the to-be-tested channel in the to-be-tested signal according to an optical spectrum of the composite signal and a power of the particular noise signal.

With reference to the second aspect, in a first possible implementation manner, the determining unit is specifically configured to determine a power of an optical signal including noise in a signal bandwidth of the to-be-tested channel according to the optical spectrum of the composite signal, and separately determine powers of inter-channel noise in a preset bandwidth between the to-be-tested channel and two adjacent channels; and determine the OSNR of the signal of the to-be-tested channel in the to-be-tested signal according to the signal bandwidth of the to-be-tested channel, the preset bandwidth, the power of the optical signal including noise in the signal bandwidth of the to-be-tested channel, the powers of the inter-channel noise, and the power of the particular noise signal.

With reference to the first possible implementation manner of the second aspect, in a second possible implementation manner, the OSNR of the signal of the to-be-tested channel in the to-be-tested signal is determined specifically based on the following formula:

$$O = \frac{S - N \times BW / BW 1}{α ( N - Δ N ) \times BW / BW 1} ,$$

where

O is the OSNR of the signal of the to-be-tested channel in the to-be-tested signal;

BW is the signal bandwidth of the to-be-tested channel;

BW₁ is the preset bandwidth;

S is the power of the optical signal including noise in the signal bandwidth of the to-be-tested channel;

N is a linear interpolant of the powers of the inter-channel noise;

ΔN is the power of the particular noise signal; and

α is a calibration coefficient and is related to a filtering characteristic of a transmission link of the to-be-tested channel.

With reference to the first possible implementation manner of the second aspect or the second possible implementation manner of the second aspect, in a third possible implementation manner, the preset bandwidth is less than the signal bandwidth of the to-be-tested channel.

With reference to the second aspect, the first possible implementation manner of the second aspect, the second possible implementation manner of the second aspect, or the third possible implementation manner of the second aspect, in a fourth possible implementation manner, the preset OSNR range is specifically 6 dB to 8 dB.

According to the method for monitoring an OSNR provided in the first aspect and the apparatus for monitoring an OSNR provided in the second aspect, a noise signal is added to a to-be-tested signal, which increases noise in a to-be-tested channel and also increases noise between the to-be-tested channel and adjacent channels. When the added noise signal can make an OSNR of a signal of the to-be-tested channel in an obtained composite signal be within a preset OSNR range, it means that the added noise signal is appropriate. In this case, a difference between a real power of the noise in the to-be-tested channel and a smallest value of a power of inter-channel noise is the smallest. Therefore, according to an optical spectrum of the composite signal, not only a power of an optical signal including noise in the to-be-tested channel can be obtained, but also the power of the noise in the to-be-tested channel can be indirectly obtained by measuring the power of the inter-channel noise. Then, an OSNR of the signal of the to-be-tested channel in the to-be-tested signal may be determined based on a power of the added noise signal. Therefore, accuracy of OSNR monitoring can be ensured.

### BRIEF DESCRIPTION OF THE DRAWINGS

The drawings are provided to further understand the present invention, and they constitute a part of the application. The drawings, along with the embodiments of the present invention, are used to explain the present invention, and pose no limitation on the present invention. In the drawings:

FIG. 1 is a schematic diagram of an OSNR out-of-band noise monitoring method defined in ITU-T G.697;

FIG. 2 is a flowchart of a method for monitoring an OSNR according to an embodiment;

FIG. 3 is a detailed flowchart of a method for monitoring an OSNR according to Embodiment 1; and

FIG. 4 is a schematic structural diagram of an apparatus for monitoring an OSNR according to Embodiment 2.

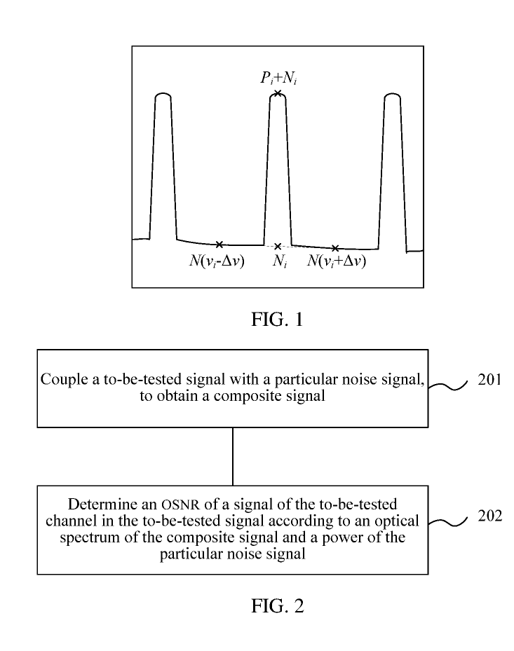

### DETAILED DESCRIPTION OF ILLUSTRATIVE EMBODIMENTS

To provide an OSNR monitoring solution that can ensure accuracy, embodiments provide a method and an apparatus for monitoring an OSNR. Preferable embodiments are described below with reference to accompanying drawings in this specification. It should be understood that the preferable embodiments described herein are merely used to describe and explain the present invention, but are not used to limit the present invention. In addition, the embodiments in this application and the characteristics of the embodiments can be combined with each other if no conflict is caused.

An embodiment provides a method for monitoring an OSNR, as shown in FIG. 2, which specifically includes the following steps.

Step 201: Couple a to-be-tested signal with a particular noise signal, to obtain a composite signal, where the particular noise signal is a noise signal that makes an OSNR of a signal of a to-be-tested channel in the composite signal be within a preset OSNR range.

Step 202: Determine an OSNR of the signal of the to-be-tested channel in the to-be-tested signal according to an optical spectrum of the composite signal and a power of the particular noise signal.

The preset OSNR range may be 6 dB to 8 dB. During actual implementation, the range may be specifically adjusted according to data such as simulation experiment data or engineering data. When the OSNR of the signal of the to-be-tested channel in the composite signal is within the preset OSNR range, a real power of noise in the channel is close to a minimum value of a power of inter-channel noise.

That is, according to the method for monitoring an OSNR provided in this embodiment, an appropriate noise signal is added to a to-be-tested signal, which decreases a difference between a real power of noise in a to-be-tested channel and a smallest value of a power of inter-channel noise. Therefore, according to an optical spectrum of a composite signal, not only a power of an optical signal including noise in the to-be-tested channel can be obtained, but also the power of the noise in the to-be-tested channel can be indirectly obtained by measuring the power of the inter-channel noise. Then, an OSNR of the signal of the to-be-tested channel in the to-be-tested signal can be determined based on a power of the added noise signal, so as to implement OSNR monitoring. It can be seen that the method for monitoring an OSNR provided in this embodiment of the present invention can ensure accuracy of OSNR monitoring, and is applicable to a high-speed optical communications network, for example, a super channel.

Further, step 202 may be specifically: determining a power of an optical signal including noise in a signal bandwidth of the to-be-tested channel according to the optical spectrum of the composite signal, and separately determining powers of inter-channel noise in a preset bandwidth between the to-be-tested channel and two adjacent channels; and determining the OSNR of the signal of the to-be-tested channel in the to-be-tested signal according to the signal bandwidth of the to-be-tested channel, the preset bandwidth, the power of the optical signal including noise in the signal bandwidth of the to-be-tested channel, the powers of the inter-channel noise, and the power of the particular noise signal.

The OSNR of the signal of the to-be-tested channel in the to-be-tested signal may be determined specifically based on the following formula:

$$O = \frac{S - N \times BW / BW 1}{α ( N - Δ N ) \times BW / BW 1} ,$$

where

O is the OSNR of the signal of the to-be-tested channel in the to-be-tested signal;

BW is the signal bandwidth of the to-be-tested channel;

BW₁ is the preset bandwidth;

S is the power of the optical signal including noise in the signal bandwidth of the to-be-tested channel;

N is a linear interpolant of the powers of the inter-channel noise;

ΔN is the power of the particular noise signal; and

α is a calibration coefficient and is related to a filtering characteristic of a transmission link of the to-be-tested channel.

The method for monitoring an OSNR provided in this embodiment is unrelated to a signal polarization state. Therefore, the method for monitoring an OSNR provided in this embodiment of the present invention not only is applicable to OSNR monitoring on a high-speed signal, but also is applicable to OSNR monitoring on a double polarization signal. An OSNR in a polarization state of a polarization multiplexing system may be independently measured by using a polarization beam splitter.

In addition, the method for monitoring an OSNR provided in this embodiment also supports simultaneous measurement of multiple channels.

An OSNR monitoring solution provided in this embodiment is described below in detail by using specific embodiments with reference to the accompanying drawings.

### Embodiment 1

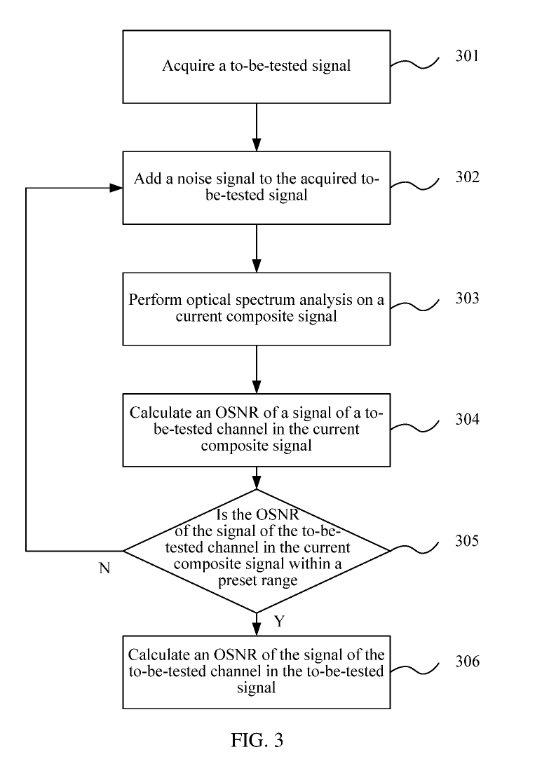

FIG. 3 is a flowchart of a method for monitoring an OSNR according to Embodiment 1, which includes the following.

Step 301: Acquire a to-be-tested signal.

During specific implementation, in an optical communications network on which OSNR monitoring needs to be performed, a few optical signals transmitted in the network may be acquired as to-be-tested signals by using an optical splitter.

Step 302: Add a noise signal to the acquired to-be-tested signal.

At the beginning of monitoring, a noise signal of an arbitrary size may be added to the acquired to-be-tested signal, and then the size of the added noise signal may be adjusted according to a determining result of the following step 305. A specific adjustment manner is further specifically described in the following step 305.

During specific implementation of step 302, the noise signal may be generated by using a wide-spectrum amplified spontaneous emission (ASE) noise source, and the noise signal generated by the ASE noise source is added to the to-be-tested signal by using an optical coupler.

Step 303: Perform optical spectrum analysis on a current composite signal.

In Embodiment 1, step 303 may be implemented by using a spectrum scanner. The scanner includes acquiring an optical spectrum of the current composite signal; and scanning an optical spectrum of a to-be-tested channel in the optical spectrum of the current composite signal by using a signal bandwidth BW of the to-be-tested channel as resolution, to acquire a greatest value as a power S of an optical signal including noise in the signal bandwidth of the to-be-tested channel; scanning an optical spectrum between the to-be-tested channel and an adjacent channel on the left of the to-be-tested channel in the optical spectrum of the composite signal by using a preset bandwidth BWi as resolution, to acquire a smallest value as a power N₁ of inter-channel noise in the preset bandwidth; and scanning an optical spectrum between the to-be-tested channel and an adjacent channel on the right of the to-be-tested channel in the optical spectrum of the composite signal, to acquire a smallest value as a power N₂ of inter-channel noise in the preset bandwidth.

In an embodiment, a resolution used in scanning an optical spectrum between channels may be the same as a resolution used in scanning an optical spectrum of a to-be-tested channel, that is, a preset bandwidth is the same as a signal bandwidth of the to-be-tested channel. In another embodiment, a resolution used in scanning an optical spectrum between channels may be different from a resolution used in scanning an optical spectrum of a to-be-tested channel, that is, a preset bandwidth is different from a signal bandwidth of the to-be-tested channel. Preferably, a resolution used in scanning an optical spectrum between channels is less than a resolution used in scanning an optical spectrum of a to-be-tested channel, that is, a preset bandwidth is less than a signal bandwidth of the to-be-tested channel; in this way, a more precise power spectrum can be obtained, so that measurement of a power of noise is more accurate, and further, preciseness of OSNR monitoring is improved.

In another embodiment, optical spectrum analysis may be implemented by using another manner. For example, optical spectrum analysis may be implemented by using a method in which a tunable filter and a power meter is used, or optical spectrum analysis is implemented by using a method in which a coherent power spectrum is used, that is, an optical spectrum of a current composite signal is acquired by using a local laser with a tunable center wavelength, an optical mixer, and a photoelectric detector, to perform spectrum calculation.

The foregoing specific implementation solution is merely exemplary, and is not intended to limit the present invention. Any optical spectrum analysis implementation manner in the prior art may be used as an implementation manner of step 303.

Step 304: Calculate an OSNR of a signal of a to-be-tested channel in the current composite signal.

The calculation may be performed specifically based on the following formula:

$${O}^{′} = \frac{S - N \times BW / BW 1}{N \times 0.1 nm / BW 1}$$

where

O′ is the OSNR of the signal of the to-be-tested channel in the current composite signal; and

N is a linear interpolant of the two powers N₁ and N₂ of the inter-channel noise.

Step 305: Determine whether the OSNR of the signal of the to-be-tested channel in the current composite signal is within a preset OSNR range.

When the OSNR of the signal of the to-be-tested channel in the current composite signal is within the preset OSNR range, it means that a size of the noise signal added to the to-be-tested signal is relatively appropriate. In this case, the added noise signal is the foregoing particular noise signal, and the linear interpolant N of the two powers N₁ and N₂ of the inter-channel noise is approximately equal to a power of noise in the to-be-tested channel. Therefore, go to step 306, to calculate an OSNR of the signal of the to-be-tested channel in the to-be-tested signal.

When the OSNR of the signal of the to-be-tested channel in the current composite signal is not within the preset OSNR range, it means that a size of the noise signal added to the to-be-tested signal is not appropriate, and it is required to return to step 302 to adjust the size of the added noise signal. A specific adjustment solution is as follows: when the OSNR of the signal of the to-be-tested channel in the current composite signal is greater than the preset OSNR range, increasing the size of the added noise signal; and when the OSNR of the signal of the to-be-tested channel in the current composite signal is less than the preset OSNR range, decreasing the size of the added noise signal.

Step 306: Calculate an OSNR of the signal of the to-be-tested channel in the to-be-tested signal.

The calculation may be performed specifically based on the following formula:

$$O = \frac{S - N \times BW / BW 1}{α ( N - Δ N ) \times BW / BW 1} ,$$

where

O is the OSNR of the signal of the to-be-tested channel in the to-be-tested signal;

ΔN is a power of the added noise signal; and

α is a calibration coefficient and is related to a filtering characteristic of a transmission link of the to-be-tested channel.

The calibration coefficient a is a positive number greater than o. When no component having a filtering characteristic exists in the transmission link of the to-be-tested channel, α=1. Generally, when a filtering effect of a component having a filtering characteristic existing in the transmission link of the to-be-tested channel is stronger, a signal bandwidth of the to-be-tested channel is narrower and the calibration coefficient a is greater.

Preferably, in another embodiment, to improve monitoring preciseness, the power S of the optical signal including noise in the signal bandwidth of the to-be-tested channel, the linear interpolant N of the powers of the inter-channel noise, and the power ΔN of the added noise signal that are needed for calculating the OSNR of the signal of the to-be-tested channel in the to-be-tested signal may be measured for multiple times, and an average value is obtained, so as to reduce a measurement error.

In conclusion, the method for monitoring an OSNR provided in this embodiment of the present invention is applicable to many application scenarios, and can to be implemented easily, and can ensure accuracy of OSNR monitoring.

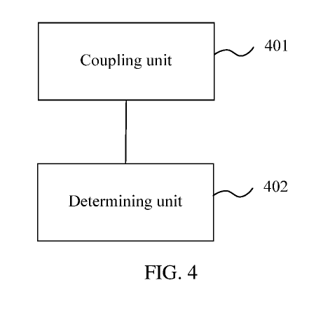

Based on the same inventive concept, correspondingly, an embodiment further provides an apparatus for monitoring an OSNR according to the method for monitoring an OSNR provided in the foregoing embodiment of the present invention, and a schematic structural diagram of the apparatus is shown in FIG. 4, which specifically includes: a coupling unit 401, configured to couple a to-be-tested signal with a particular noise signal, to obtain a composite signal, where the particular noise signal is a noise signal that makes an OSNR of a signal of a to-be-tested channel in the composite signal be within a preset OSNR range; and a determining unit 402, configured to determine an OSNR of the signal of the to-be-tested channel in the to-be-tested signal according to an optical spectrum of the composite signal and a power of the particular noise signal.

The apparatus further includes a judging unit, where the judging unit is configured to determine whether the OSNR of the signal of the to-be-tested channel in the composite signal is within the preset OSNR range, and a specific determining manner is the same as step 5 and a related part of step 305. Details are not described herein again.

Further, the determining unit 402 is specifically configured to determine a power of an optical signal including noise in a signal bandwidth of the to-be-tested channel according to the optical spectrum of the composite signal, and separately determine powers of inter-channel noise in a preset bandwidth between the to-be-tested channel and two adjacent channels; and determine the OSNR of the signal of the to-be-tested channel in the to-be-tested signal according to the signal bandwidth of the to-be-tested channel, the preset bandwidth, the power of the optical signal including noise in the signal bandwidth of the to-be-tested channel, the powers of the inter-channel noise, and the power of the particular noise signal.

Further, the determining unit 402 is specifically configured to determine the OSNR of the signal of the to-be-tested channel in the to-be-tested signal based on the following formula:

$$O = \frac{S - N \times BW / BW 1}{α ( N - Δ N ) \times BW / BW 1} ,$$

where

O is the OSNR of the signal of the to-be-tested channel in the to-be-tested signal;

BW is the signal bandwidth of the to-be-tested channel;

BW₁ is the preset bandwidth;

S is the power of the optical signal including noise in the signal bandwidth of the to-be-tested channel;

N is a linear interpolant of the powers of the inter-channel noise;

ΔN is the power of the particular noise signal; and

α is a calibration coefficient and is related to a filtering characteristic of a transmission link of the to-be-tested channel.

Preferably, the preset bandwidth is less than the signal bandwidth of the to-be-tested channel.

Further, the preset OSNR range is specifically 6 dB to 8 dB.

Functions of the foregoing units may correspond to corresponding processing steps in the process shown in FIG. 2 or FIG. 3. Details are not described herein again.

During actual implementation, the coupling unit 401 may be implemented by using an optical coupler, to obtain the composite signal, and then the spectrum of the composite signal is obtained by using an existing spectrum analyzing device, such as a spectrum scanner. The determining unit 402 and the judging unit may be implemented by using special-purpose hardware, or may be implemented by using software, which is not limited in the present invention.

A person skilled in the art should understand that the embodiments may be provided as a method, a system, or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a particular function in one or more processes in the flowcharts and/or in one or more blocks in the block diagrams.

Although some preferred embodiments of the present invention have been described, persons skilled in the art can make changes and modifications to these embodiments once they learn the basic inventive concept. Therefore, the following claims are intended to be construed as to cover the preferred embodiments and all changes and modifications falling within the scope of the present invention.

Obviously, persons skilled in the art can make various modifications and variations to the embodiments of the present invention without departing from the spirit and scope of the embodiments of the present invention. The present invention is intended to cover these modifications and variations provided that they fall within the scope of protection defined by the following claims and their equivalent technologies.

What is claimed is:

1. A method, comprising:
coupling a to-be-tested signal with a particular noise signal, to obtain a composite signal, wherein the particular noise signal is a noise signal that makes an optical signal-to-noise ratio (OSNR) of a signal of a to-be-tested channel in the composite signal be within a preset OSNR range; and
determining an OSNR of the signal of the to-be-tested channel in the to-be-tested signal according to an optical spectrum of the composite signal and a power of the particular noise signal.

2. The method according to claim 1, wherein determining the OSNR of the signal of the to-be-tested channel in the to-be-tested signal comprises:
determining a power of an optical signal comprising noise in a signal bandwidth of the to-be-tested channel according to the optical spectrum of the composite signal, and separately determining powers of inter-channel noise in a preset bandwidth between the to-be-tested channel and two adjacent channels; and
determining the OSNR of the signal of the to-be-tested channel in the to-be-tested signal according to the signal bandwidth of the to-be-tested channel, the preset bandwidth, the power of the optical signal comprising noise in the signal bandwidth of the to-be-tested channel, the powers of the inter-channel noise, and the power of the particular noise signal.

3. The method according to claim 2, wherein the OSNR of the signal of the to-be-tested channel in the to-be-tested signal is determined based on the following relation:
$$O = \frac{S - N \times BW / BW 1}{α ( N - Δ N ) \times BW / BW 1} ,$$
wherein
O represents the OSNR of the signal of the to-be-tested channel in the to-be-tested signal;
BW represents the signal bandwidth of the to-be-tested channel;
BW₁ represents the preset bandwidth;
S represents the power of the optical signal comprising noise in the signal bandwidth of the to-be-tested channel;
N represents a linear interpolant of the powers of the inter-channel noise;
ΔN represents the power of the particular noise signal; and
α represents a calibration coefficient and is related to a filtering characteristic of a transmission link of the to-be-tested channel.

4. The method according to claim 2, wherein the preset bandwidth is less than the signal bandwidth of the to-be-tested channel.

5. The method according to claim 1, wherein the preset OSNR range is from 6 dB to 8 dB.

6. An apparatus, comprising:
a coupling unit, configured to couple a to-be-tested signal with a particular noise signal, to obtain a composite signal, wherein the particular noise signal is a noise signal that makes an optical signal-to-noise ratio (OSNR) of a signal of a to-be-tested channel in the composite signal be within a preset OSNR range; and
a determining unit, configured to determine an OSNR of the signal of the to-be-tested channel in the to-be-tested signal according to an optical spectrum of the composite signal and a power of the particular noise signal.

7. The apparatus according to claim 6, wherein the determining unit is further configured to determine a power of an optical signal comprising noise in a signal bandwidth of the to-be-tested channel according to the optical spectrum of the composite signal, and separately determine powers of inter-channel noise in a preset bandwidth between the to-be-tested channel and two adjacent channels; and
determine the OSNR of the signal of the to-be-tested channel in the to-be-tested signal according to the signal bandwidth of the to-be-tested channel, the preset bandwidth, the power of the optical signal comprising noise in the signal bandwidth of the to-be-tested channel, the powers of the inter-channel noise, and the power of the particular noise signal.

8. The apparatus according to claim _{7,} wherein the determining unit is further configured to determine the OSNR of the signal of the to-be-tested channel in the to-be-tested signal based on the following relation:
$$O = \frac{S - N \times BW / BW 1}{α ( N - Δ N ) \times BW / BW 1} ,$$
wherein
O represents the OSNR of the signal of the to-be-tested channel in the to-be-tested signal;
BW represents the signal bandwidth of the to-be-tested channel;
BW₁ represents the preset bandwidth;
S represents the power of the optical signal comprising noise in the signal bandwidth of the to-be-tested channel;
N represents a linear interpolant of the powers of the inter-channel noise;
ΔN represents the power of the particular noise signal; and
α represents a calibration coefficient and is related to a filtering characteristic of a transmission link of the to-be-tested channel.

9. The apparatus according to claim _{7,} wherein the preset bandwidth is less than the signal bandwidth of the to-be-tested channel.

10. The apparatus according to claim 6, wherein the preset OSNR range is from 6 dB to 8 dB.

11. An apparatus, comprising:
a coupler, configured to couple a to-be-tested signal with a particular noise signal, to obtain a composite signal, wherein the particular noise signal is a noise signal that makes an optical signal-to-noise ratio (OSNR) of a signal of a to-be-tested channel in the composite signal be within a preset OSNR range;
a processor; and
a computer-readable storage medium storing a program to be executed by the processor, the program including instructions for:
determining an OSNR of the signal of the to-be-tested channel in the to-be-tested signal according to an optical spectrum of the composite signal and a power of the particular noise signal.

12. The apparatus according to claim ii, wherein the program further includes instructions for determining a power of an optical signal comprising noise in a signal bandwidth of the to-be-tested channel according to the optical spectrum of the composite signal, and separately determining powers of inter-channel noise in a preset bandwidth between the to-be-tested channel and two adjacent channels; and
determining the OSNR of the signal of the to-be-tested channel in the to-be-tested signal according to the signal bandwidth of the to-be-tested channel, the preset bandwidth, the power of the optical signal comprising noise in the signal bandwidth of the to-be-tested channel, the powers of the inter-channel noise, and the power of the particular noise signal.

13. The apparatus according to claim 12, wherein the program further includes instructions for determining the OSNR of the signal of the to-be-tested channel in the to-be-tested signal based on the following relation:
$$O = \frac{S - N \times BW / BW 1}{α ( N - Δ N ) \times BW / BW 1} ,$$
wherein
O represents the OSNR of the signal of the to-be-tested channel in the to-be-tested signal;
BW represents the signal bandwidth of the to-be-tested channel;
BW₁ represents the preset bandwidth;
S represents the power of the optical signal comprising noise in the signal bandwidth of the to-be-tested channel;
N represents a linear interpolant of the powers of the inter-channel noise;
ΔN represents the power of the particular noise signal; and
α represents a calibration coefficient and is related to a filtering characteristic of a transmission link of the to-be-tested channel.

14. The apparatus according to claim 12, wherein the preset bandwidth is less than the signal bandwidth of the to-be-tested channel.

15. The apparatus according to claim ii, wherein the preset OSNR range is from 6 dB to 8 dB.
